(19) United States
(12) Patent Application Publication
(10) Pub. No.: US 2025/0222792 A1
(43) Pub. Date: Jul. 10, 2025

(54) SWITCHING METHOD FOR POWER MODULES, CONTROL APPARATUS AND CHARGING PILE

(71) Applicant: Autel Digital Power Co., Ltd., Shenzhen (CN)

(72) Inventors: Wenhan LAN, Shenzhen (CN); Xinhang WAN, Shenzhen (CN); Yuping XIONG, Shenzhen (CN)

(73) Assignee: Autel Digital Power Co., Ltd., Shenzhen, GD (CN)

(21) Appl. No.: 19/091,568

(22) Filed: Mar. 26, 2025

Related U.S. Application Data
(63) Continuation of application No. PCT/CN2023/115424, filed on Aug. 29, 2023.

(30) Foreign Application Priority Data
Sep. 26, 2022 (CN) 202211176659.3

(51) Int. Cl. B60L 53/10; H02J 7/00

(52) U.S. Cl. CPC B60L 53/11; H02J 7/0068

(57) ABSTRACT

The present disclosure provides a switching method for power modules, a control apparatus and a charging pile. The switching method includes: acquiring required power for a vehicle when being charged and the output power of a first power module; determining a switching mode according to the required power and the output power of the first power module; and completing switching according to the switching mode. By means of the method, a concave fluctuation phenomenon can be reduced during the switching of power modules, thereby improving the charging stability and security.

### CROSS-REFERENCE TO RELATED APPLICATIONS

The present application is a continuation application of International Patent Application No. PCT/CN2023/115424, filed on Aug. 29, 2023, which claims priority to Chinese Patent Application No. 202211176659.3 filed on Sep. 26, 2022, the entire disclosures of both of which are incorporated herein by reference for all purposes.

### TECHNICAL FIELD

The present disclosure relates to the technical field of electronics, and in particular to a switching method for power modules, a control apparatus and a charging pile.

### BACKGROUND

With the rapid development of new energy technology, the number of electric vehicles is increasing, and the demand for charging infrastructure is increasing. At present, the common charging piles in the market are divided into alternating-current charging piles and direct-current charging piles, and the charging power of direct-current charging piles is much greater than that of alternating-current charging piles.

Generally, for the direct-current charging pile, power is output to a direct-current busbar via multiple groups of power modules, and performing power output via multiple groups of power modules would result in output switching among power modules so as to meet different charging power requirements. However, when multiple groups of power modules switch the same direct-current busbar simultaneously, a large concave fluctuation phenomenon between the output power of the direct-current busbar and the output power of the required power of the vehicle will arise, i.e., the difference between the output power of the direct-current busbar and the required power of the vehicle is large, as shown by the concave a and the concave b in FIG. 1, and such concave fluctuation phenomenon will affect the stability of vehicle charging when using the charging pile.

### SUMMARY

It is an object of embodiments of the present disclosure to provide a switching method for power modules, and a control apparatus and a charging pile, which can reduce the difference of the difference between the output power of a direct-current busbar and the required power of a vehicle when the power module is switched, and reduce the concave fluctuation phenomenon, thereby increasing the stability and security of the charging pile when charging a vehicle.

In order to solve the above technical problem, one technical solution adopted by the embodiments of the present disclosure is to provide a switching method for power modules, which is applied to a charging pile. The switching method includes: acquiring required power for a vehicle when being charged, and the output power of a first power module; determining a switching mode according to the required power and the output power of the first power module; in response to determining that the switching mode is a module addition mode, establishing a connection between a second power module and a direct-current busbar, and controlling the output power of the first power module and output power of the second power module, and completing switching when the first power module and the second power module meet a first preset condition; and in response to determining that the switching mode is a module reduction mode, controlling the output power of a first sub-power module in the first power module and the output power of a second sub-power module in the first power module, and disconnecting the second sub-power module from the direct-current busbar and completing switching when the second sub-power module meets a second preset condition.

In a second aspect, embodiments of the present disclosure provide a control apparatus, including: at least one processor, and a memory communicatively connected to the at least one processor; where the memory stores instructions executable by the at least one processor, the instructions being executed by the at least one processor to enable the at least one processor to perform the switching method of any one of the first aspect above.

In a third aspect, embodiments of the present disclosure also provide a charging pile, including: a power module, a switching apparatus, and a control apparatus as described in the second aspect above; the power module is connected to a direct-current busbar via the switching apparatus, and the control apparatus is respectively connected to the power module and the switching apparatus.

In a fourth aspect, embodiments of the present disclosure provide a computer-readable storage medium storing computer-executable instructions for causing a computer to perform the method of the first aspect above.

In a fifth aspect, embodiments of the present disclosure provide a computer program product including a computer program stored on a computer-readable storage medium, the computer program including program instructions which, when executed by a computer, cause the computer to perform the method of the first aspect above.

### BRIEF DESCRIPTION OF DRAWINGS

One or more embodiments are illustrated by way of example in the accompanying drawings which correspond to and are not to be construed as limiting the embodiments, in which elements/modules and steps having the same reference numeral designations represent like elements/modules and steps throughout, and in which the drawings are not to be construed as limiting in scale unless otherwise specified.

FIG. 1 is a schematic diagram showing required power of a vehicle and output power of direct-current busbar during charging of a charging pile according to the related art;

FIG. 2 is a schematic structural diagram showing a charging pile according to an embodiment of the present disclosure;

FIG. 3 is a schematic structural diagram showing a control apparatus according to an embodiment of the present disclosure;

FIG. 4 is a schematic flow diagram showing a switching method according to an embodiment of the present disclosure;

FIG. 5 is a schematic diagram showing required power of a vehicle and output power of direct-current busbar during charging of a charging pile according to an embodiment of the present disclosure;

FIG. 6 is a schematic flow diagram showing a step S20 according to an embodiment of the present disclosure;

FIG. 7 is a partial schematic flow diagram showing a switching method according to an embodiment of the present disclosure;

FIG. 8 is a schematic flow diagram showing a step S31 according to an embodiment of the present disclosure;

FIG. 9 is a partial schematic flow diagram showing another switching method according to an embodiment of the present disclosure; and

FIG. 10 is a schematic flow diagram showing a step S41 according to an embodiment of the present disclosure.

### DETAILED DESCRIPTION

Hereinafter, the present disclosure will be described in detail with reference to specific embodiments. The following embodiments will aid a person skilled in the art in further understanding of the present disclosure, but do not limit the present disclosure in any way. It should be noted that several variations and modifications can be made by a person skilled in the art without departing from the inventive concept. These are all within the scope of the present disclosure.

To facilitate an understanding of the present disclosure, a more particular description of the application will be rendered by reference to specific embodiments thereof which are illustrated in the appended drawings. Unless defined otherwise, all technical and scientific terms used in the description have the same meaning as commonly understood by a person skilled in the art to which the present disclosure belongs. The terminology used in the description of the present disclosure herein is for the purpose of describing embodiments only and is not intended to be limiting of the present disclosure. As used herein, the term “and/or” includes any and all combinations of one or more of the associated listed items.

It should be noted that, if not conflicting, various features of the embodiments of the present disclosure may be combined with each other within the scope of the present disclosure. In addition, although the functional module division is performed in the device schematic diagram, in some cases, it may be different from the module division in the device. Furthermore, the terms “first”, “second”, and the like as used herein do not limit the data and order of execution, but merely distinguish the same items or similar items having substantially the same function or action.

In a first aspect, embodiments of the present disclosure provide a charging pile, including: a power module, a switching apparatus and a control apparatus. The power module is connected to a direct-current busbar via the switching apparatus, and the control apparatus is respectively connected to the power module and the switching apparatus.

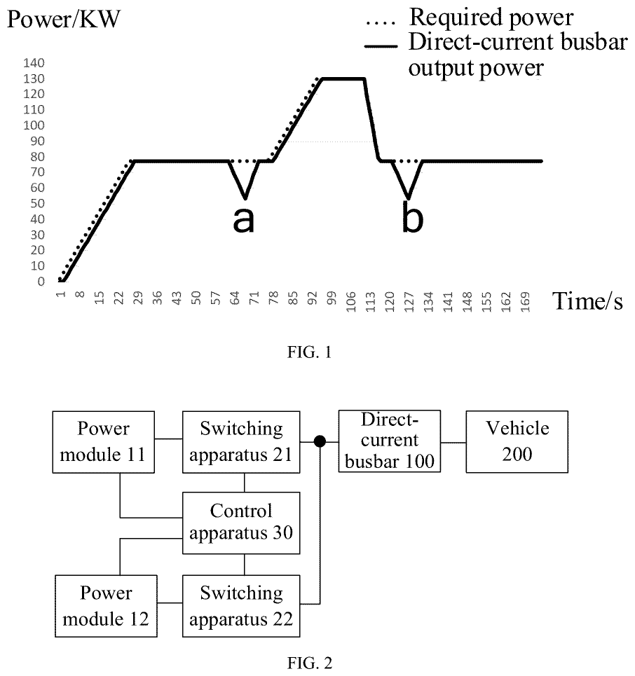

According to one or more embodiments, referring to FIG. 2, the charging pile includes a power module 11, a switching apparatus 21, a power module 12 and a switching apparatus 22, where an output end of the power module 11 is connected to a first end of the switching apparatus 21, an output end of the power module 12 is connected to a first end of the switching apparatus 12, and a second end of the switching apparatus 21 and a second end of the switching apparatus 22 are connected to a direct-current busbar 100. Thus, the connection of the power modules 11 and 12 to the direct-current busbar 100 can be controlled by controlling the switching apparatuses 21 and 22. In practice, the number of power modules provided in the charging pile can be set as required, and need not be limited in the present embodiment.

For example, when the switching apparatus 21 is switched on and the switching apparatus 22 is switched on, the power module 11 is connected to the direct-current busbar 100, and the power module 12 is connected to the direct-current busbar 100; at this time, the output power on the direct-current busbar 100 is a sum of the output power of the power module 11 and the output power of the power module 12; and at this time, there is a power module which can be reduced, for example, the power module 11 or the power module 12 can be reduced, i.e., cither the switching apparatus 21 or the switching apparatus 22 can be switched off, so that the power module 11 is disconnected from the direct-current busbar 100, or the power module 12 is disconnected from the direct-current busbar 100. When the switching apparatus 21 is switched on and the switching apparatus 22 is switched off, the power module 11 is connected to the direct-current busbar 100, and the power module 12 is not connected to the direct-current busbar 100; at this time, the output power on the direct-current busbar 100 is only the output power of the power module 11, and there is an additional power module, for example, the switching apparatus 22 can be re-switched on, so that the power module 12 can be re-connected to the direct-current busbar 100. When the switching apparatus 21 is switched off and the switching apparatus 22 is switched on, the power module 11 is not connected to the direct-current busbar 100, and the power module 12 is connected to the direct-current busbar 100; at this time, the output power on the direct-current busbar 100 is only the output power of the power module 12, and there is an additional power module, for example, the switching apparatus 21 can be re-switched on, so that the power module 11 can be re-connected to the direct-current busbar 100. When the switching apparatus 21 is switched off and the switching apparatus 22 is switched off, the power module 11 is not connected to the direct-current busbar 100, and the power module 12 is not connected to the direct-current busbar 100; at this time, the output power on the direct-current busbar 100 is zero, and there is an additional power module, for example, the switching apparatus 21 can be re-switched on so that the power module 11 can be re-connected to the direct-current busbar 100, and/or the switching apparatus 22 can be re-switched on so that the power module 12 can be re-connected to the direct-current busbar 100.

The control apparatus may be an STM8, STM16 or STM32 series microcontroller, or any other suitable microcontroller processor which may be used to receive, process, store and output data. The control apparatus has the same structure and function as the control apparatus described in the second aspect below and can be used for performing the switching method of the power module according to any one of the embodiments provided by the present disclosure, and the method is described in detail with reference to the following description and will not be described in detail herein.

The power module includes at least one power module, where in the power module, an input end of each power module is connected to an alternating-current power supply, an output end of each power module is connected to a corresponding switching apparatus, and a control end of each power module is connected to the control apparatus. The power module can output power to a direct-current busbar under the control of a control apparatus, and the power module can be an ACDC module or a combination of an ACDC module and a DCDC module, which can be set as required, and is not limited herein. For the specific circuit structure of the power module, reference can be made to the related art, which is not limited herein.

The switching apparatus may include at least one power switch tube, such as a direct-current contactor, an Insulated Gate Bipolar Transistor (IGBT) device, an Integrated Gate-Commutated Thyristor (IGCT) device, a Gate Turn-Off Thyristor (GTO) device, a Silicon Controlled Rectifier (SCR) device, a Junction Field-Effect Transistor (JFET) device, a Mos Controlled GTO (MCT) device, a gallium nitride (GaN)-based power device, a silicon carbide (SiC)-based power device, and the like, and the specific number and type can be set as required, which is not limited herein.

In the charging pile according to an embodiment of the present disclosure, the control apparatus can perform the switching method according to any one of the method embodiments of the present disclosure, so as to reduce the difference between the output power of the direct-current busbar and the required power of the vehicle when the power module is switched, and reduce the concave fluctuation phenomenon, thereby increasing the stability and security of the charging pile when charging a vehicle.

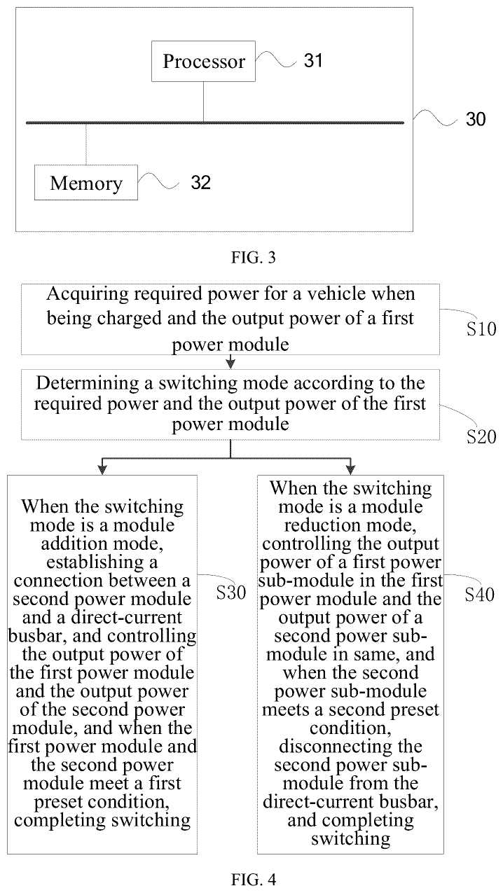

In a second aspect, embodiments of the present disclosure provide a control apparatus. Referring to FIG. 3, a hardware structure capable of executing the switching method of the power module described in FIGS. 4 and 6 to 10 is shown. The control apparatus may be the control apparatus as shown in FIG. 2.

The control apparatus includes: at least one processor 31; and a memory 32 communicatively connected to the at least one processor 31, one processor 31 being exemplified in FIG. 3. The memory 32 stores instructions executable by the at least one processor 31, the instructions are executed by the at least one processor 31 to enable the at least one processor 31 to perform the switching method described below referring to FIGS. 4, 6 and 10. The processors 31 and the memory 32 may be connected via a busbar or in other ways, and the connection via a busbar is exemplified in FIG. 3.

The memory 32 is a non-volatile computer-readable storage medium that can be used to store a non-volatile software program, a non-volatile computer-executable program, and modules, such as program instructions/modules corresponding to the execution switching method in the embodiment of the present disclosure. The processor 31 executes various functional applications of the server and data processing by executing non-volatile software programs, instructions and modules stored in the memory 32, i.e., implements the switching method described in the method embodiments described below.

The memory 32 may include a program storage area and a data storage area, where the program storage area may store an operating system and an application required by at least one function; the storage data area may store data or the like created according to the use of a pixel correction apparatus. The memory 32 may include a high-speed random-access memory and may also include a non-volatile memory, such as at least one magnetic disk storage apparatus, flash memory apparatus, or other non-volatile solid state storage apparatuses. In some of these embodiments, the memory 32 may optionally include memory remotely located relative to the processor 31, which may be connected to the pixel correction apparatus via a network. Embodiments of such networks include, but are not limited to, the Internet, Intranets, local area networks, mobile communication networks, and combinations thereof.

The one or more modules are stored in the memory 32 and, when executed by the one or more processors 31, perform the switching method in any of the method embodiments described below, for example, perform the method of FIGS. 4, 6 and 10 described below.

The above-mentioned product can perform the method provided by the embodiments of the present disclosure, and has corresponding functional modules and advantages for performing the method. Details not described in detail in the present example can be found in the methods provided in the embodiments of the present disclosure.

In a third aspect, embodiments of the present disclosure provide a switching method for power modules, applied to a charging pile. Referring to FIG. 4, the switching method includes:

Step S10, acquiring required power for a vehicle when being charged and output power of a first power module.

According to one or more embodiments, when the charging pile is connected to the vehicle via the direct-current busbar, the control apparatus communicates with a battery management system of the vehicle, so that the required power for charging the vehicle can be acquired in real time.

The first power module is a power module which has been connected to the direct-current busbar at the initial time when the direct-current busbar is connected to the vehicle and can output power to the direct-current busbar. For example, at the initial time, in FIG. 2, if both the switching apparatuses 21 and 22 are switched on, the first power module includes the power modules 11 and 12, and at this time, the number of power modules in the first power module is 2; if the switching apparatus 21 is switched on and the switching apparatus 22 is switched off, the first power module only includes the power module 11, and at this time, the number of power modules in the first power module is 1; if the switching apparatus 21 is switched off and the switching apparatus 22 is switched on, the first power module only includes the power modules 12, and at this time, the number of power modules in the first power module is 1.

When acquiring the output power of the first power module, the output power of the first power module can be obtained by acquiring an output voltage and an output current on the direct-current busbar, and calculating according to the output voltage and the output current. In practice, a voltage sampling unit and a current sampling unit can be provided on the direct-current busbar, so that the output voltage on the direct-current busbar can be obtained via the voltage sampling unit, and the output current on the direct-current busbar can be obtained via the current sampling unit, where the voltage sampling unit and the current sampling unit can be all suitable devices in the related art.

Step S20, determining a switching mode according to the required power and the output power of the first power module.

It can be understood that when the required power is greater than the output power of the first power module, it indicates that the number of power modules currently connected to the direct-current busbar is insufficient, and the number of power modules needs to be increased, and then it is determined that the switching mode is a module addition mode. When the required power is less than the output power of the first power module, it indicates that the number of power modules currently connected to the direct-current busbar is redundant, and the number of power modules needs to be reduced, and then it is determined that the switching mode is a module reduction mode. When the required power is equal to the output power of the first power module, it indicates that the current number of power modules connected to the direct-current busbar is just suitable, and neither module addition nor module reduction is required.

Step S30, when the switching mode is a module addition mode, establishing a connection between a second power module and a direct-current busbar, and controlling the output power of the first power module and the output power of the second power module, and when the first power module and the second power module meet a first preset condition, completing switching.

The second power module is a power module which is not connected to the direct-current busbar at an initial time. For example, at an initial time, in FIG. 2, if the switching apparatus 21 is switched on and the switching apparatus 22 is switched off, the second power module only includes the power module 12, and the number of power modules in the second power module is 1; if the switching apparatus 21 is switched off and the switching apparatus 22 is switched on, the second power module only includes the power module 11, and the number of power modules in the second power module is 1; and if the switching apparatuses 21 and 22 are both switched off, the second power module includes the power modules 11 and 12, and the number of power modules in the second power module is 2.

After entering the module addition mode, when establishing the connection between the second power module and the direct-current busbar, the output power of the first power module and the second power module is corrected, so that the output power meets the first preset condition and the module addition process is ended, then the switching is completed.

Step S40, when the switching mode is a module reduction mode, controlling the output power of a first sub-power module in the first power module and the output power of a second sub-power module in same, and when the second sub-power module meets a second preset condition, disconnecting the second sub-power module from the direct-current busbar, and completing switching.

The first sub-power module and the second sub-power module are power modules connected to the direct-current busbar at an initial time. For example, at the initial time, in FIG. 2, if the switching apparatuses 21 and 22 are both switched on, the first sub-power module may include a power module 11, and the second sub-power module may include a power module 12, and at this time, the number of power modules in the first sub-power module and the number of power modules in the second sub-power module are both 1; alternatively, the first sub-power module may include a power module 12, the second sub-power module may include a power module 11, and the number of power modules in the first sub-power module and the number of power modules in the second sub-power module are both 1.

After entering the module reduction mode, the output power of the first sub-power module and the second sub-power module can be corrected so as to meet a second preset condition, the second sub-power module is disconnected from the direct-current busbar, the module reduction process is ended, and the switching is completed.

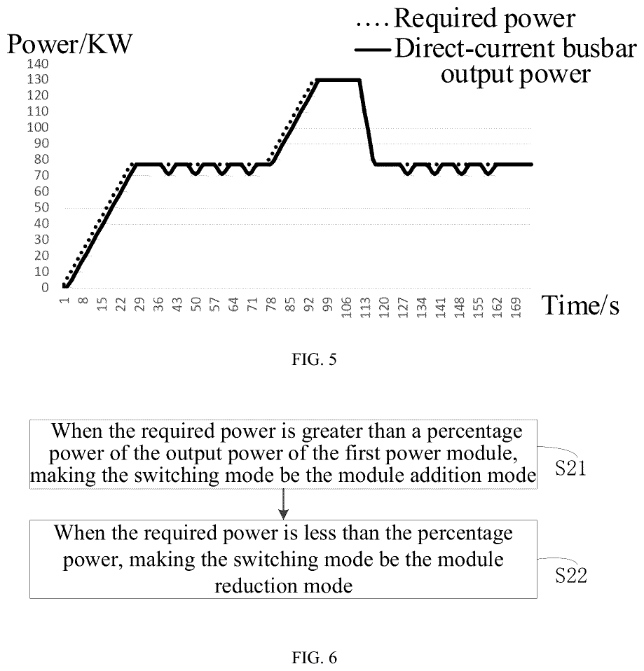

In the switching method, after entering the module addition mode or module reduction mode, by controlling the output power of each power module connected to the direct-current busbar, the output power on the direct-current busbar is corrected to keep the overall output total power of the direct-current busbar unchanged or to reduce fluctuations, and the module addition/reduction processing is completed, and in this manner, the module addition/reduction is performed, as shown in FIG. 5, so as to reduce the difference of the difference between the output power on the direct-current busbar and the required power of a vehicle, thereby reducing the concave fluctuation phenomenon and increasing the stability and security of the charging pile when charging a vehicle.

In some of these embodiments, referring to FIG. 6, the step S20 includes:

Step S21, when the required power is greater than a percentage power of the output power of the first power module, making the switching mode be the module addition mode.

Step S22, when the required power is less than the percentage power, making the switching mode be the module reduction mode.

The percentage power is the output power of the first power module multiplied by a power value of a preset percentage, where the preset percentage value can be set by a charging pile designer himself according to the efficiency of the power module, for example, the preset percentage can be selected as a value within a range of 50%-95%. Comparing the required power with the output power of the first power module directly, in the embodiment of the present disclosure, the efficiency of the power module is considered by comparing the required power at the time of charging the vehicle with the percentage power in real time, so that the accuracy of the determination of the switching mode can be improved.

In some of these embodiments, the charging pile further includes a switching apparatus. The establishing the connection between the second power module from the direct-current busbar includes: the switching apparatus correspondingly connected to the second power module is switched on so that the second power module is connected to the direct-current busbar via the correspondingly connected switching apparatus. The disconnecting the second power module from the direct-current busbar includes: the switching apparatus correspondingly connected to the second sub-power module is disconnected so that the second sub-power module is connected to the direct-current busbar via the correspondingly connected switching apparatus.

According to one or more embodiments, at the initial time, in FIG. 2, if the switching apparatus 21 is switched on, the switching apparatus 22 is switched off, and at this time, the module addition mode is entered, and if the power module 12 is to be added, the switching apparatus 22 may be switched on. At the initial time, in FIG. 2, if both the switching apparatuses 21 and 22 are switched on and the module reduction mode is entered at this time, the switching apparatus 22 is switched off if the power module 12 is to be reduced.

It can be seen that the power module can be reconnected to or disconnected from the direct-current busbar by controlling the switching apparatus correspondingly connected to the power module, so that the purpose of module addition or module reduction of the charging pile can be achieved.

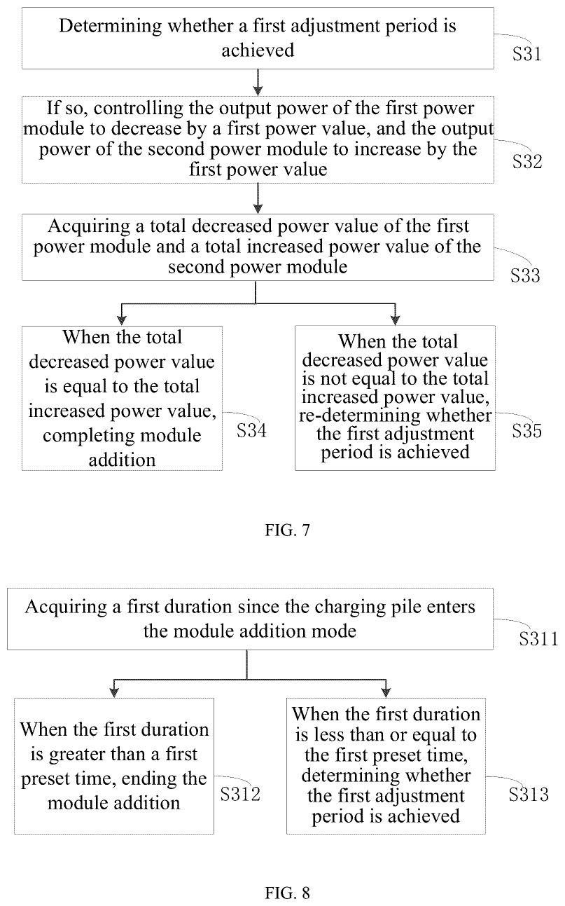

In some embodiments, referring to FIG. 7, the controlling the output power of the first power module and the output power of the second power module, and when the first power module and the second power module meet the first preset condition, completing switching includes:

Step S31, determining whether the first adjustment period is achieved.

Step S32, if so, controlling the output power of the first power module to decrease by a first power value, and the output power of the second power module to increase by the first power value.

Step S33, acquiring a total decreased power value of the first power module and a total increased power value of the second power module.

Step S34, when the total decreased power value is equal to the total increased power value, completing module addition.

Step S35, when the total decreased power value is not equal to the total increased power value, re-determining whether the first adjustment period is achieved.

The first adjustment period is the time for executing step S32 to step S35 at intervals; for example, the first adjustment period can be set to be between 500 ms and 2000 ms; for example, when the first adjustment period is set to be 500 ms, i.e., after entering the module addition mode, the output power of the first power module and the second power module is controlled once every 500 ms until the total decreased power value is equal to the total increased power value, and the switching is completed.

According to one or more embodiments, at the initial time, in FIG. 2, if the switching apparatus 21 is switched on, the switching apparatus 22 is switched off, and a module addition mode is entered at this time; if the power module 12 is to be increased, the switching apparatus 22 is first switched on, and then it is confirmed whether a first adjustment period is achieved at this time; if so, the output power of the power module 11 is controlled to decrease by a first power value ΔP, and the output power of the power module 12 is controlled to increase by the first power value ΔP; then a total decreased power value of the power module 11 and a total increased power value of the power module 12 before and after controlling the output power are acquired; then, it is determined whether the total decreased power value is equal to the total increased power value, and if so, the module addition process is completed, and if not, it is re-determined whether the next first adjustment period is achieved.

When the total decreased power value of the power module 11 is acquired, the output power of the power module 11 can be acquired first before the output power of the power module 11 is controlled to decrease by the first power value ΔP, then when the output power of the power module 11 is controlled to decrease by the first power value ΔP, the output power of the power module 11 is acquired again, and finally, the total decreased power value of the power module 11 can be obtained by subtracting the first output power of the power module from the second output power of the power module, and taking an absolute value from the difference obtained. Likewise, the output power of the power module 12 can be acquired first before the output power of the power module 12 is controlled to increase by the first power value ΔP, then when the output power of the power module 12 is increased by the first power value ΔP, the output power of the power module 12 is acquired again, and finally, the total increased power value of the power module 12 can be obtained by subtracting the first output power of the power module from the second output power of the power module, and taking an absolute value from the difference obtained.

In an embodiment of the present disclosure, by periodically adjusting the power outputs of the first power module and the second power module, the total decreased power value can be equal to the total increased power value, and by smoothly equalizing the output power of the first power module and the output power of the second power module, the total output power on the direct-current busbar can be kept constant or fluctuate less, and a module addition process is completed, so that the difference of the difference between the output power on the direct-current busbar and the required power of the vehicle can be reduced, thereby reducing the concave fluctuation phenomenon and increasing the stability and security of the charging pile when charging a vehicle.

In some of these embodiments, referring to FIG. 8, the step S31 includes:

Step S311, acquiring a first duration since the charging pile enters the module addition mode.

Step S312, when the first duration is greater than a first preset time, ending the module addition.

Step S313, when the first duration is less than or equal to the first preset time, determining whether the first adjustment period is achieved.

According to one or more embodiments, after entering the module addition mode, a timer may be started to acquire a first duration since the charging pile enters the module addition mode. The first preset time can be set between 20 s to 50 s, and by setting the first preset time, after entering the module addition mode, the phenomenon that the charging pile always fails to meet the first preset condition when power correction is performed, and the control flow enters a dead cycle can be avoided, thereby improving the reliability of the power module addition process.

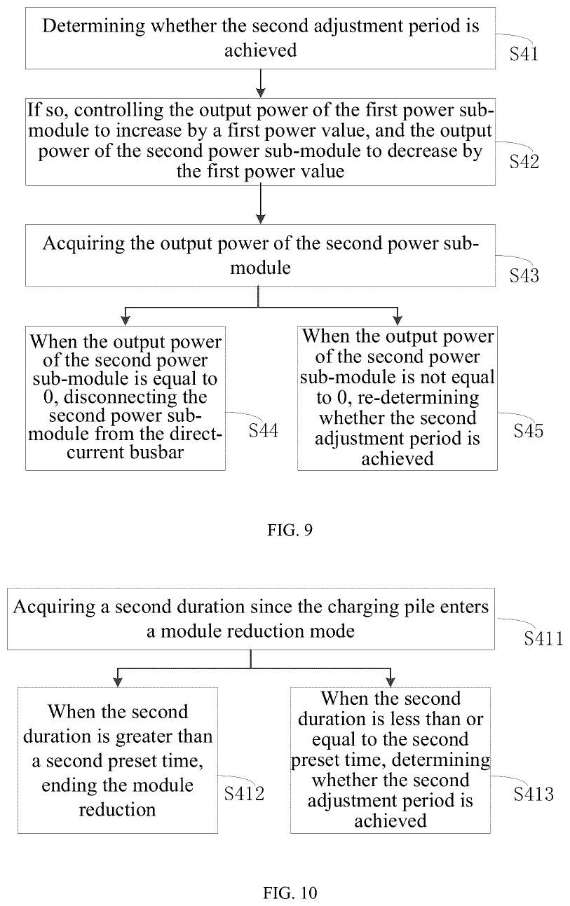

In some embodiments, referring to FIG. 9, the when the switching mode is the module reduction mode, controlling output power of the first sub-power module in the first power module and output power of the second sub-power module in same, and when the second sub-power module meets the second preset condition, disconnecting the second sub-power module from the direct-current busbar, and completing switching includes:

Step S41, determining whether the second adjustment period is achieved.

Step S42, if so, controlling the output power of the first sub-power module to increase by a first power value, and the output power of the second sub-power module to decrease by the first power value.

Step S43, acquiring the output power of the second sub-power module.

Step S44, when the output power of the second sub-power module is equal to 0, disconnecting the second sub-power module from the direct-current busbar.

Step S45, when the output power of the second sub-power module is not equal to 0, re-determining whether the second adjustment period is achieved.

The second adjustment period is the time for executing step S42 to step S45 at intervals; for example, the second adjustment period can be set to be between 500 ms and 2000 ms; when the first adjustment period is set to be 500 ms, i.e., after entering a module reduction mode, the output power of the first sub-power module and the second sub-power module is controlled once every 500 ms until the total decreased power value is equal to the total increased power value, the second sub-power module is disconnected from the direct-current busbar, and the switching is completed.

According to one or more embodiments, at the initial time, in FIG. 2, if both the switching apparatuses 21 and 22 have been switched on, and a module reduction mode is entered at this time, if the first sub-power module is the power module 11 and the second sub-power module is the power module 12 at this time, it is confirmed whether the second adjustment period is achieved at this time, and if so, the output power of the power module 11 is controlled to increase by a first power value ΔP, and the output power of the power module 12 is controlled to decrease by the first power value ΔP; then, the output power of the power module 12 is acquired when the control of the output power of the power module 12 to decrease by the first power value ΔP is completed; then, it is determined whether the output power of the power module 12 is equal to 0, if so, the switching apparatus 22 is switched off, and the module reduction process is completed, and if not, it is reconfirmed whether the next second adjustment period is achieved.

In the embodiment of the present disclosure, by periodically adjusting the output power of the first sub-power module and the output power of the second sub-power module, the output power of the second sub-power module can be equal to 0, and the required power of a vehicle is all provided by the first sub-power module, and by smoothly equalizing the output power of the first sub-power module and the output power of the second sub-power module, the total output power on the direct-current busbar can be kept constant or the fluctuation is small, and the module reduction process is completed, so that the difference of the difference between the output power on the direct-current busbar and the required power of a vehicle can be reduced, thereby reducing the concave fluctuation phenomenon and increasing the stability and security of the charging pile when charging a vehicle.

In some of these embodiments, referring to FIG. 10, the step S41 includes:

Step S411, acquiring a second duration since the charging pile enters a module reduction mode.

Step S412, when the second duration is greater than a second preset time, ending the module reduction.

Step S413, when the second duration is less than or equal to the second preset time, determining whether the second adjustment period is achieved.

According to one or more embodiments, after entering the module reduction mode, a timer may be started to acquire a second duration since the charging pile enters the reduction mode. The second preset time can be set between 20 s-50 s, and by setting the second preset time, after entering the module reduction mode, the phenomenon that the charging pile always fails to meet the second preset condition when power correction is performed and the control flow enters a dead cycle can be avoided, thereby improving the reliability of the power module reduction process.

In some of these embodiments, the first power value is obtained by the following formula:

$$Δ P = ( \vert P 1 - P 2 \vert ) / ( N \times k ) ;$$

where ΔP is the first power value, k is an adjustment speed coefficient, N is a total number of power modules, P1 is the required power, and P2 is the output power of the first power module.

According to one or more embodiments, the adjustment speed coefficient can be set according to the adjustment response speed of the power module, and it can be understood that the faster the response speed of the power module, the greater the adjustment speed coefficient is. When the switching mode is a module addition mode, N is the sum of the number of power modules in the first power module and the number of power modules in the second power module; and when the switching mode is in the module reduction mode, N is the number of power modules in the first power module, i.e., the sum of the number of power modules in the first sub-power module and the number of power modules in the second sub-power module.

In a fourth aspect, embodiments of the present disclosure further provide a non-volatile computer-readable storage medium having stored thereon computer-executable instructions that are executed by one or more processors, for example, to perform the method of FIGS. 4, 6 and 10 described above.

In a fifth aspect, embodiments of the present disclosure further provide a computer program product including a computer program stored on a non-volatile computer-readable storage medium, the computer program including program instructions which, when executed by a computer, cause the computer to perform a switching method in any of the method embodiments described above, for example, to perform the method of FIGS. 4 and 6 to 10 described above.

It should be noted that the embodiments of the apparatus described above are merely schematic, where the elements illustrated as separate components may or may not be physically separated, and the elements shown as elements may or may not be physical elements, i.e., may be in one place, or may also be distributed over a plurality of network elements. Some or all the modules may be selected as required to achieve the purpose of the solution of the present embodiment.

From the above description of the embodiments, it will be clear to a person skilled in the art that the embodiments can be implemented by means of software plus a general-purpose hardware platform, but also by means of hardware. Based on the understanding, the above technical solutions substantially or otherwise contributing to the related art may be embodied in the form of a software product, which may be stored in a computer-readable storage medium, such as ROM/RAM, a magnetic disk, an compact disk, etc., and includes a plurality of instructions for executing the method according to each embodiment or some parts of the embodiments by at least one computer device (which may be a personal computer, a server, or a network device, etc.).

Compared to the related art, the advantageous effects of the present disclosure are as follows: a switching method for power modules, and a control apparatus and a charging pile. The switching method includes: acquiring required power for a vehicle when being charged, and the output power of a first power module; determining a switching mode according to the required power and the output power of the first power module; when the switching mode is a module addition mode, establishing a connection between a second power module and a direct-current busbar, and controlling the output power of the first power module and the output power of the second power module, and when the first power module and the second power module meet a first preset condition, completing switching; and when the switching mode is a module reduction mode, controlling the output power of a first sub-power module in the first power module and the output power of a second sub-power module in same, and when the second sub-power module meets a second preset condition, disconnecting the second sub-power module from the direct-current busbar, and completing switching. By the above-mentioned method, it is possible to reduce the difference between the output power of the direct-current busbar and the required power of the vehicle when the power module is switched, and reduce the concave fluctuation phenomenon, thereby increasing the stability and security of the charging pile when charging a vehicle.

Finally, it should be noted that the above-mentioned embodiments are merely illustrative of the technical solutions of the present disclosure, and do not limit same; the technical features in the above embodiments or in different embodiments may also be combined under the idea of the present disclosure, the steps may be implemented in any order, and there are many other variations of the different aspects of the present disclosure as above, which are not provided in the details for the sake of brevity; although the present disclosure has been described in detail Referring to the foregoing embodiments, a person skilled in the art will appreciate that: the technical solutions disclosed in the above-mentioned embodiments can still be amended, or some of the technical features thereof can be replaced by equivalents; however, these modifications or substitutions do not bring the essence of the corresponding technical solutions out of the scope of the technical solutions of the various an embodiment of the present disclosure. While the present disclosure has been described with reference to specific embodiments thereof, it should be understood by a person skilled in the art that various changes may be made and equivalents may be substituted for elements thereof without departing from the scope of the application. Accordingly, the scope of protection of the present disclosure shall be governed by the claims.

What is claimed is:

1. A switching method for power modules, applied to a charging pile, the switching method comprising:
acquiring required power for a vehicle when being charged and output power of a first power module;
determining a switching mode according to the required power and the output power of the first power module;
in response to determining that the switching mode is a module addition mode, establishing a connection between a second power module and a direct-current busbar, controlling the output power of the first power module and output power of the second power module, and completing switching when the first power module and the second power module meet a first preset condition; and
in response to determining that the switching mode is a module reduction mode, controlling output power of a first sub-power module in the first power module and output power of a second sub-power module in the first power module, disconnecting the second sub-power module from the direct-current busbar, and completing switching when the second sub-power module meets a second preset condition.

2. The switching method according to claim 1, wherein determining the switching mode according to the required power and the output power of the first power module comprises:
in response to determining that the required power is greater than a percentage power of the output power of the first power module, making the switching mode be a module addition mode; and
in response to determining that the required power is less than the percentage power of the output power of the first power module, making the switching mode be a module reduction mode.

3. The switching method according to claim 2, wherein controlling the output power of the first power module and the output power of the second power module, and completing switching when the first power module and the second power module meet a first preset condition comprises:
determining whether a first adjustment period is achieved;
in response to determining that the first adjustment period is achieved, controlling the output power of the first power module to decrease by a first power value and the output power of the second power module to increase by the first power value, and acquiring a total decreased power value of the first power module and a total increased power value of the second power module;
in response to determining that the total decreased power value is equal to the total increased power value, completing module addition; and
in response to determining that the total decreased power value is not equal to the total increased power value, re-determining whether the first adjustment period is achieved.

4. The switching method according to claim 3, wherein determining whether the first adjustment period is achieved comprises:
acquiring a first duration since the charging pile enters the module addition mode;
in response to determining that the first duration is greater than a first preset time, ending the module addition; and
in response to determining that the first duration is less than or equal to the first preset time, determining whether the first adjustment period is achieved.

5. The switching method according to claim 2, wherein controlling output power of the first sub-power module in the first power module and output power of a second sub-power module in the first power module, disconnecting the second sub-power module from the direct-current busbar, and completing switching when the second sub-power module meets a second preset condition comprises:
determining whether a second adjustment period is achieved;
in response to determining that the second adjustment period is achieved, controlling the output power of the first sub-power module to increase by a first power value and the output power of the second sub-power module to decrease by the first power value, and acquiring the output power of the second sub-power module;
in response to determining that the output power of the second sub-power module is equal to 0, disconnecting the second sub-power module from the direct-current busbar; and
in response to determining that the output power of the second sub-power module is not equal to 0, re-determining whether the second adjustment period is achieved.

6. The switching method according to claim 5, wherein determining whether the second adjustment period is achieved comprises:
acquiring a second duration since the charging pile enters a module reduction mode;
in response to determining that the second duration is greater than a second preset time, ending module reduction; and
in response to determining that the second duration is less than or equal to the second preset time, determining whether the second adjustment period is achieved.

7. The switching method according to claim 3, wherein the first power value is obtained by the following formula:
$$Δ P = ( \vert P 1 - P 2 \vert ) / ( N \times k ) ;$$
wherein ΔP is the first power value, k is an adjustment speed coefficient, N is a total number of power modules, P1 is the required power, and P2 is the output power of the first power module.

8. The switching method according to claim 3, wherein the charging pile further comprises a switching apparatus;
wherein the establishing a connection between a second power module and a direct-current busbar comprises:
switching on the switching apparatus correspondingly connected to the second power module so that the second power module is connected to the direct-current busbar via the correspondingly connected switching apparatus;
wherein disconnecting the second sub-power module from the direct-current busbar comprises:
disconnecting the switching apparatus correspondingly connected to the second sub-power module so that the second sub-power module is connected to the direct-current busbar via the correspondingly connected switching apparatus.

9. A control apparatus, comprising:
at least one processor; and
a memory communicatively connected to the at least one processor; wherein
the memory stores an instruction executable by the at least one processor, and the instruction is executed by the at least one processor to cause the at least one processor to perform acts comprising:
acquiring required power for a vehicle when being charged and output power of a first power module;
determining a switching mode according to the required power and the output power of the first power module;
in response to determining that the switching mode is a module addition mode, establishing a connection between a second power module and a direct-current busbar, controlling the output power of the first power module and output power of the second power module, and completing switching when the first power module and the second power module meet a first preset condition; and
in response to determining that the switching mode is a module reduction mode, controlling output power of a first sub-power module in the first power module and output power of a second sub-power module in the first power module, disconnecting the second sub-power module from the direct-current busbar, and completing switching when the second sub-power module meets a second preset condition.

10. A charging pile, comprising:
a power module;
a switching apparatus; and
a control apparatus,
wherein the power module is connected to a direct-current busbar via the switching apparatus, and the control apparatus is respectively connected to the power module and the switching apparatus;
wherein the control apparatus comprises:
at least one processor; and
a memory communicatively connected to the at least one processor;
wherein the memory stores an instruction executable by the at least one processor, and the instruction is executed by the at least one processor, causes the at least one processor to perform acts comprising:
acquiring required power for a vehicle when being charged and output power of a first power module;
determining a switching mode according to the required power and the output power of the first power module;
in response to determining that the switching mode is a module addition mode, establishing a connection between a second power module and a direct-current busbar, controlling the output power of the first power module and output power of the second power module, and completing switching when the first power module and the second power module meet a first preset condition; and
in response to determining that the switching mode is a module reduction mode, controlling output power of a first sub-power module in the first power module and output power of a second sub-power module in the first power module, disconnecting the second sub-power module from the direct-current busbar, and completing switching when the second sub-power module meets a second preset condition.

11. The switching method according to claim 4, wherein the first power value is obtained by the following formula:
$$Δ P = ( \vert P 1 - P 2 \vert ) / ( N \times k ) ;$$
wherein ΔP is the first power value, k is an adjustment speed coefficient, N is a total number of power modules, P1 is the required power, and P2 is the output power of the first power module.

12. The switching method according to claim 5, wherein the first power value is obtained by the following formula:
$$Δ P = ( \vert P 1 - P 2 \vert ) / ( N \times k ) ;$$
wherein ΔP is the first power value, k is an adjustment speed coefficient, N is a total number of power modules, P1 is the required power, and P2 is the output power of the first power module.

13. The switching method according to claim 6, wherein the first power value is obtained by the following formula:
$$Δ P = ( \vert P 1 - P 2 \vert ) / ( N \times k ) ;$$
wherein ΔP is the first power value, k is an adjustment speed coefficient, N is a total number of power modules, P1 is the required power, and P2 is the output power of the first power module.

14. The switching method according to claim 4, wherein the charging pile further comprises a switching apparatus;
wherein the establishing a connection between a second power module and a direct-current busbar comprises:
switching on the switching apparatus correspondingly connected to the second power module so that the second power module is connected to the direct-current busbar via the correspondingly connected switching apparatus;
wherein the disconnecting the second sub-power module from the direct-current busbar comprises:
disconnecting the switching apparatus correspondingly connected to the second sub-power module so that the second sub-power module is connected to the direct-current busbar via the correspondingly connected switching apparatus.

15. The switching method according to claim 5, wherein the charging pile further comprises a switching apparatus;
wherein the establishing a connection between a second power module and a direct-current busbar comprises:
switching on the switching apparatus correspondingly connected to the second power module so that the second power module is connected to the direct-current busbar via the correspondingly connected switching apparatus;
wherein the disconnecting the second sub-power module from the direct-current busbar comprises:
disconnecting the switching apparatus correspondingly connected to the second sub-power module so that the second sub-power module is connected to the direct-current busbar via the correspondingly connected switching apparatus.

16. The switching method according to claim 6, wherein the charging pile further comprises a switching apparatus;
wherein the establishing a connection between a second power module and a direct-current busbar comprises:
switching on the switching apparatus correspondingly connected to the second power module so that the second power module is connected to the direct-current busbar via the correspondingly connected switching apparatus;
wherein the disconnecting the second sub-power module from the direct-current busbar comprises:
disconnecting the switching apparatus correspondingly connected to the second sub-power module so that the second sub-power module is connected to the direct-current busbar via the correspondingly connected switching apparatus.

17. The control apparatus according to claim 9, wherein determining the switching mode according to the required power and the output power of the first power module comprises:
in response to determining that the required power is greater than a percentage power of the output power of the first power module, making the switching mode be a module addition mode; and
in response to determining that the required power is less than the percentage power of the output power of the first power module, making the switching mode be a module reduction mode.

18. The control apparatus according to claim 17, wherein controlling the output power of the first power module and the output power of the second power module, and completing switching when the first power module and the second power module meet a first preset condition comprises:
determining whether a first adjustment period is achieved;
in response to determining that the first adjustment period is achieved, controlling the output power of the first power module to decrease by a first power value and the output power of the second power module to increase by the first power value, and acquiring a total decreased power value of the first power module and a total increased power value of the second power module;
in response to determining that the total decreased power value is equal to the total increased power value, completing module addition; and
in response to determining that the total decreased power value is not equal to the total increased power value, re-determining whether the first adjustment period is achieved.

19. The charging pile according to claim 10, wherein determining the switching mode according to the required power and the output power of the first power module comprises:
in response to determining that the required power is greater than a percentage power of the output power of the first power module, making the switching mode be a module addition mode; and
in response to determining that the required power is less than the percentage power of the output power of the first power module, making the switching mode be a module reduction mode.

20. The charging pile according to claim 19, wherein controlling the output power of the first power module and the output power of the second power module, and completing switching when the first power module and the second power module meet a first preset condition comprises:
determining whether a first adjustment period is achieved;
in response to determining that the first adjustment period is achieved, controlling the output power of the first power module to decrease by a first power value and the output power of the second power module to increase by the first power value, and acquiring a total decreased power value of the first power module and a total increased power value of the second power module;
in response to determining that the total decreased power value is equal to the total increased power value, completing module addition; and
in response to determining that the total decreased power value is not equal to the total increased power value, re-determining whether the first adjustment period is achieved.
